(19) United States
(12) Patent Application Publication
(10) Pub. No.: US 2011/0018784 A1
(43) Pub. Date: Jan. 27, 2011

(54) ANTENNA, IN PARTICULAR FOR RADAR SIGNALS, AS WELL AS METHOD AND USE

(76) Inventors: Joerg Hilsebecher, Hildesheim (DE); Uwe Wostradowski, Renningen (DE); Stefan Gaier, Stuttgart (DE); Joachim Selinger, Stuttgart (DE)

Correspondence Address: KENYON & KENYON LLP, ONE BROADWAY, NEW YORK, NY, 10004, US

(21) Appl. No.: 12/735,050

(22) PCT Filed: Oct. 21, 2008
(86) PCT No.: PCT/EP2008/064186

§ 371 Date: Sep. 21, 2010

(30) Foreign Application Priority Data
Dec. 20, 2007 (DE) 10 2007 061 738.2

(51) Int. Cl. H01Q 21/08; H01P 11/00

(52) U.S. Cl. 343/893; 29/600

(57) ABSTRACT

In an antenna, e.g., for radar signals, a substrate carries two pairs of diametrically opposed antenna elements, first diametrically opposed antenna elements being oriented in a direction that considerably deviates from the direction of second diametrically opposed antenna elements, e.g., by 90°, and the first and second diametrically opposed antenna elements each lying symmetrically with respect to the point of intersection of their orientation directions.

### BACKGROUND OF THE INVENTION

The present invention relates to an antenna, e.g., for radar signals, made up of a plurality of antenna elements for transmit and receive operation, and also a method for producing such an antenna, and a use of the antenna.

### DESCRIPTION OF RELATED ART

From European patent EP 1 476 921 B1, it is known to dispose receiving elements of a radar antenna along a first straight line, and transmission elements along two additional straight lines. All of these straight lines are situated parallel to each other, the additional straight lines being disposed at the same distance to the first straight line. With this system it is possible to achieve higher resolution in a first preferred orientation (azimuth) than in another preferred orientation, e.g., elevation. In addition, direct crosstalk by the transmission elements to the receiving elements can be avoided.

In the radar antenna system according to published international patent application WO 2004/061475 A1, a plurality of columns of receiving elements is provided and at least one column of transmission elements. These columns can be switched on and off. Under at least two columns a phase control is provided. This allows for a variable range and simple evaluation of the angular deviation.

### BRIEF SUMMARY OF THE INVENTION

A substrate carries two pairs of diametrically opposed antenna elements, first diametrically opposed antenna elements 1, 3 being oriented in a direction that considerably deviates from the direction of second diametrically opposed antenna elements 2, 4, e.g., by 90°, the first and the second opposite-lying antenna elements each being disposed symmetrically with respect to the point of intersection of their orientation directions. In this manner, it is possible to determine angles of incidence of reflections for an object both in elevation and in azimuth using, in particular, only four antenna elements on one chip. In addition, a self-adjustment in at least one axial direction is possible. A misalignment compensation may take place both on the receiving and the transmission side. In addition to accommodating the antenna elements on one chip, it is also possible to accommodate the required HF components for the control.

According to one advantageous development, the first diametrically opposed antenna elements are azimuth-oriented, and the second diametrically opposed antenna elements are elevation-oriented. This facilitates the determination of the angles of incidence in azimuth and elevation.

It is advantageous that the antenna elements are positioned in centrosymmetrical and axis-symmetrical manner relative to each other. This contributes to a self-alignment.

Patch elements, in particular having a square shape, are advantageously suitable as antenna elements. They are easily applied on a substrate and contribute to a flat design.

If paired antenna elements lying diametrically opposed are provided as transmission or as receiving elements, then this facilitates the control (wiring expense) and the evaluation.

If all antenna elements are provided as receiving elements but only one pair of opposite-lying antenna elements as transmission elements, then it is possible to determine an optimal angle of the angles of incidence of radar beams reflected at objects.

If all antenna elements are provided both as receiving as well as transmission elements, then narrow transmission lobes having increased resolution of the received radar signals are able to be generated.

If transmission elements are able to be operated via a control Circuit at different phase positions, then simple beam swinging may be accomplished.

In a rapid change of the phase position (micro-scanning) in an axial direction, an angular determination in this axial direction is possible.

A slow change of the phase position adjusts the beam direction in such a way that a misalignment of the radar antenna is able to be compensated at least in an axial direction.

If the antenna is provided with a focusing lens, then the range for reflected radar radiation is able to be increased and/or the illumination region is able to be controlled.

The antenna according to the present invention is especially suitable for mid-range radar in motor vehicle radar systems for driver assistance.

### BRIEF DESCRIPTION OF THE SEVERAL VIEWS OF THE DRAWING

FIG. 1 shows a plan view of an antenna system having four patch elements according to the present invention.

FIG. 2 shows a perspective view of the antenna according to FIG. 1.

FIG. 3 shows a system according to FIG. 2 having a focusing lens.

FIG. 4 shows the control of the transmission and receiving elements.

### DETAILED DESCRIPTION OF THE INVENTION

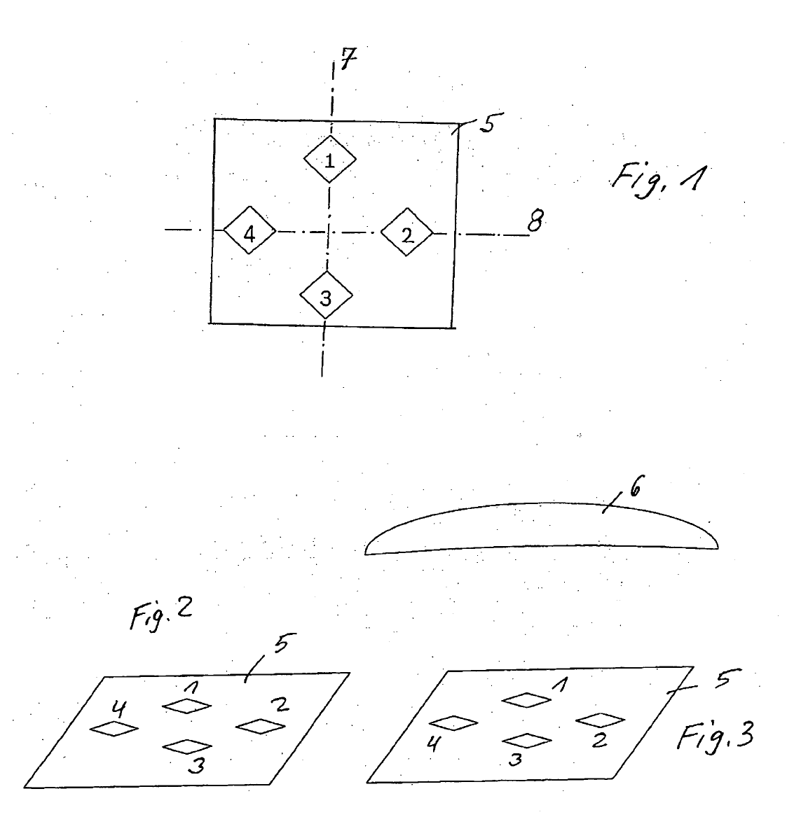

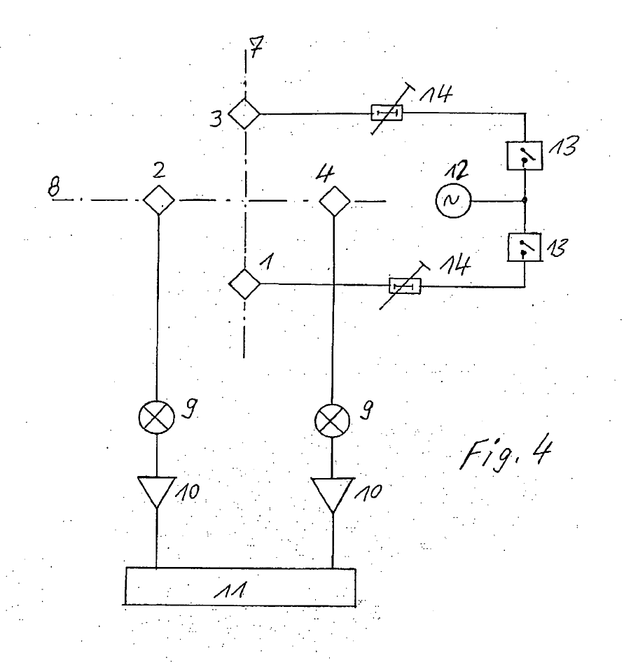

The antenna according to the present invention as shown in FIG. 1 or FIG. 2 is made up of a spatial array of four patch antenna elements 1, 2, 3, and 4 on an HF substrate 5 or an MMIC. A radar sensor having such an antenna array may be designed both as planar concept, i.e., more than two antenna elements may be configured in azimuth and elevation, and also under a focusing lens 6 according to FIG. 3. The four square antenna elements 1, 2, 3 and 4, each standing on one of their respective tips in FIG. 1, are positioned across from each other in the form of pairs, antenna elements 1 and 3 being positioned on top of one another in elevation 7, and antenna elements 2 and 4 being positioned next to each other in azimuth 8. The orientation axes of elevation 7 and azimuth 8 are situated perpendicular to each other, in particular. All antenna elements 1, 2, 3, 4 are disposed in axis-symmetrical and centrosymmetrical manner relative to each other (points of intersection axes 7 and 8). This aids in the self-alignment, regardless of which ones of the antenna elements 1, 2, 3, 4 are operated as transmission and/or as receiving elements.

The four antenna elements 1, 2, 3, 4 may have the following alternative operating modes:
a) Antenna elements 1 and 3 are pure transmission elements, and antenna elements 2 and 4 are pure receiving elements;
b) Antenna elements 1 and 3 are transmission and receiving elements, and antenna elements 2 and 4 are pure receiving elements;
c) All antenna elements 1, 2, 3 and 4 are both transmission and receiving elements.

The spatial alignment of this array may vary, depending on the application (given angle in azimuth and/or elevation). Each receiving element is connected to a receiving circuit. As shown in FIG. 4, for example, in the case of a), this receiving circuit is usually made up of a mixer 9, possibly a receiving amplifier 10, and a shared evaluation device 11 for detecting and evaluating the receive signals. The transmitter circuit is made up of an HF oscillator 12, to which an HF switch 13 for generating radar pulses is connected in series for each one of the transmit branches. All transmission channels are able to be switched on and off individually and therefore allow for a control of the illumination of the detection range.

Furthermore, the transmission channels for transmission elements 1 and 3 are controllable in such a way that their phase position is able to be adjusted in a variable manner, e.g., by phase shifters 14. This produces a transmission and/or receiving channel having a controllable directional characteristic. As a result, there are two additional application options:
Variant A: rapid modification of the phase difference provides for rapid beam swinging (micro-scanning) in the axial direction of transmission elements 1 and 3 and thereby enables an angular detection in this axis;
Variant B: slow modification of the phase difference adjusts the beam direction in such a way that a misalignment of the radar antenna in axial direction 1, 3 is able to be compensated.

The vertical misalignment compensation may be implemented both on the transmission and on the receiving side.
i. Sweeping purely on the transmission side (one combined transmission channel) allows for the 1−3 angular determination of the reflection, by measuring the phase difference of the two separate receiving channels, for instance so as to measure the reflex height in order to determine the possibility of overtravel/undertravel.
ii. Beam sweeping on the transmission and receiving side (one combined transmission and receiving channel) does not allow a direct 1−3 angular determination.

In both variants A and B, a 2−4 angle determination of the reflections is possible as a result of the phase differences of channels 2 (1+3), 4.

Variants a), b) and c) and variants A, B are partially combinable. This results in quite different characteristics for the operation of the antenna according to the present invention.

To produce such an antenna, at least two diametrically opposed antenna elements are applied on a substrate, first diametrically opposed antenna elements being aligned in a direction that considerably deviates from the direction of second diametrically opposed antenna elements, in particular by 90°, and the first and the second diametrically opposed antenna elements each being disposed symmetrically with respect to the point of intersection of their orientation direction.

1-13. (canceled)

14. An antenna system for radar signals, comprising:
a substrate; and
two pairs of antenna elements positioned on the substrate, wherein each pair includes diametrically opposed antenna elements, a first pair of diametrically opposed antenna elements are oriented in a first line along a first direction, a second pairs of diametrically opposed antenna elements are oriented in a second line along a second direction deviating from the first direction by approximately 90° and intersecting the first line, and wherein the first and second pairs of antenna elements each lie symmetrically with respect to the point of intersection of the first and second lines.

15. The antenna system as recited in claim 14, wherein the first pair of diametrically opposed antenna elements are oriented in elevation, and wherein the second pair of diametrically opposed antenna elements are oriented in azimuth.

16. The antenna system as recited in claim 15, wherein the antenna elements of the first and second pairs of antenna elements are positioned in centro-symmetrical and axis-symmetrical manner with respect to each other.

17. The antenna system as recited in claim 16, wherein the antenna elements of the first and second pairs of antenna elements are patch elements having square shapes.

18. The antenna system as recited in claim 16, wherein the first pair of diametrically opposed antenna elements are transmission elements and the second pair of diametrically opposed antenna elements are receiving elements.

19. The antenna system as recited in claim 16, wherein both the first and second pairs of diametrically opposed antenna elements are receiving elements, and wherein the first pair of diametrically opposed antenna elements are also transmission elements.

20. The antenna system as recited in claim 16, wherein each antenna element of the first and second pairs of diametrically opposed antenna elements is both a receiving element and a transmission element.

21. The antenna system as recited in claim 16, further comprising:
a control circuit for controlling the operation of the transmission elements using different phase positions.

22. The antenna system as recited in claim 21, wherein the control circuit is configured to implement a rapid modification of the phase positions in such a way that an angular determination is able to take place at least in the orientation direction of the two diametrically opposed antenna elements of each pair.

23. The antenna system as recited in claim 21, wherein the control circuit is configured to implement a slow modification of the phase positions in such a way that a misalignment of the antenna system in the orientation direction of the two diametrically opposed antenna elements of each pair is compensated.

24. The antenna system as recited in claim 21, further comprising a focusing lens.

25. A method for producing an antenna for radar signals, comprising:
providing a substrate; and
positioning two pairs of antenna elements on the substrate, wherein each pair includes diametrically opposed antenna elements, a first pair of diametrically opposed antenna elements are oriented in a first line along a first direction, a second pairs of diametrically opposed antenna elements are oriented in a second line along a second direction deviating from the first direction by approximately 90° and intersecting the first line, and wherein the first and second pairs of antenna elements each lie symmetrically with respect to the point of intersection of the first and second lines.
